(19) United States
(12) Patent Application Publication
(10) Pub. No.: US 2023/0205036 A1
(43) Pub. Date: Jun. 29, 2023

(54) FLEXIBLE DISPLAY DEVICE

(71) Applicant: E Ink Holdings Inc., HSINCHU (TW)

(72) Inventors: Yi-Sheng LIN, HSINCHU (TW); Chia-Chun YEH, HSINCHU (TW); Chen-Chu TSAI, HSINCHU (TW)

(21) Appl. No.: 18/051,011

(22) Filed: Oct. 31, 2022

(30) Foreign Application Priority Data
Dec. 29, 2021 (TW) 110149273

(51) Int. Cl. G02F 1/167; G02F 1/1679; G09F 9/30

(52) U.S. Cl. CPC G02F 1/167; G02F 1/1679; G09F 9/301

(57) ABSTRACT

A flexible display device includes a thin-film transistor (TFT) array substrate, a cover film, an electronic ink layer, an edge sealant, an electrode layer, and a reinforcement layer. The electronic ink layer is located between the TFT array substrate and the cover film. The edge sealant is located between the TFT array substrate and the cover film and surrounds the electronic ink layer. The edge sealant defines a packaging area that vertically overlaps the edge sealant. The electrode layer is located on the electronic ink layer. The reinforcement layer is disposed along the packaging area.

### RELATED APPLICATIONS

This application claims priority to Taiwan Application Serial Number 110149273, filed Dec. 29, 2021, which is herein incorporated by reference.

### BACKGROUND

### Field of Invention

The present disclosure relates to a flexible display device.

### Description of Related Art

In today’s various consumer electronic product markets, flexible display panels have been widely used as display screens for electronic products, such as electronic paper. An electronic ink (e-ink) layer of a flexible display panel is mainly formed of an electrophoresis fluid and white and black charged particles doped in the electrophoresis fluid. The white and black charged particles are driven to move by applying a voltage to the electronic ink layer, such that each pixel displays a black color, a white color or a gray level. Since the flexible display panel utilizes an incident light (e.g., sunlight, indoor ambient light, or front light) that irradiates the electronic ink layer to achieve the purpose of display, the flexible display panel needs no backlight, which reduces power consumption.

Flexible display devices often use thinned laminate designs to improve flexibility. However, when a selected thin film material (e.g., an electrode layer) is thinner than an underlying soft plastic material (e.g., a sealant), the thin film material may wrinkle due to bending to form a compressed state. If an adhesion between the film material and the soft plastic material is insufficient, buckling will further occur.

### SUMMARY

One aspect of the present disclosure provides a flexible display device.

According to some embodiments of the present disclosure, a flexible display device includes a thin-film transistor (TFT) array substrate, a cover film, an electronic ink layer, an edge sealant, an electrode layer, and a reinforcement layer. The electronic ink layer is located between the TFT array substrate and the cover film. The edge sealant is located between the TFT array substrate and the cover film and surrounds the electronic ink layer. The edge sealant defines a packaging area that vertically overlaps the edge sealant. The electrode layer is located on the electronic ink layer. The reinforcement layer is disposed along the packaging area.

In some embodiments, the reinforcement layer is located on the cover film.

In some embodiments, a material of the reinforcement layer is polyimide (PI), polyethylene terephthalate (PET), resin, or metal.

In some embodiments, the reinforcement layer is located on a top surface of the electrode layer.

In some embodiments, the flexible display device further includes a first optical adhesive located on the electrode layer and the reinforcement layer.

In some embodiments, a Young’s modulus of the reinforcement layer is greater than a Young’s modulus of the first optical adhesive.

In some embodiments, the reinforcement layer is located between the electrode layer and the edge sealant.

In some embodiments, the reinforcement layer has a plurality of segments that are separated from each other, and a portion of the edge sealant extends to a position between the segments.

In some embodiments, a Young’s modulus of the reinforcement layer is in a range from 10 GPa to 500 GPa.

In some embodiments, the flexible display device further includes a first optical adhesive and a functional layer. The first optical adhesive is located on the electrode layer. The functional layer is located on the first optical adhesive, wherein the reinforcement layer is located between the functional layer and the electrode layer.

In some embodiments, the flexible display device further includes a first optical adhesive, a functional layer, and a second optical adhesive. The first optical adhesive is located on the electrode layer. The functional layer is located on the first optical adhesive. The second optical adhesive is located between the functional layer and the cover film.

In some embodiments, the flexible display device further includes a decorative ink layer disposed along the packaging area and located between the cover film and the second optical adhesive.

In some embodiments, a Young’s modulus of the decorative ink layer is greater than a Young’s modulus of the second optical adhesive.

In some embodiments, the reinforcement layer has an inner portion, and a thickness of the inner portion is gradually decreased form the edge sealant to the electronic ink layer such that the inner portion has an inclined surface.

In some embodiments, a thickness of the reinforcement layer is in a range from 15 µm to 100 µm.

In some embodiments, the flexible display device further includes a bottom protection layer and a third optical adhesive located between the bottom protection layer and the TFT array substrate.

According to some embodiments of the present disclosure, a flexible display device includes a thin-film transistor (TFT) array substrate, a cover film, an electronic ink layer, an edge sealant, an electrode layer, and a reinforcement layer. The electronic ink layer is located between the TFT array substrate and the cover film. The edge sealant surrounds the electronic ink layer. The electrode layer is located on the electronic ink layer. The reinforcement layer is above the edge sealant and vertically overlaps the edge sealant.

In the aforementioned embodiments of the present disclosure, since the flexible display device includes the reinforcement layer disposed along the packaging area, a position of a neutral axis of the packaging area (i.e., a position having no stress when bending the flexible display device) may be adjusted. When the flexible display device is bent, the reinforcement layer can transform films (e.g., the electrode layer, the electronic ink layer, and the TFT array substrate) that are at risk of buckling in the packaging area from a compressed state to a neutral state or a tensile state, thereby avoiding wrinkles and buckling, and preventing interfacial delamination occurs during bending.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top view of a flexible display device according to one embodiment of the present disclosure.

FIG. 2 is a cross-sectional view of the flexible display device taken along line 2-2 of FIG. 1.

FIG. 3 is a cross-sectional view of a flexible display device according to one embodiment of the present disclosure.

FIG. 4 is a cross-sectional view of a flexible display device according to one embodiment of the present disclosure.

FIG. 5 is a cross-sectional view of a flexible display device according to one embodiment of the present disclosure.

FIG. 6 is a cross-sectional view of a flexible display device according to one embodiment of the present disclosure.

FIG. 7 is a cross-sectional view of a flexible display device according to one embodiment of the present disclosure.

### DESCRIPTION OF THE EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Throughout the discussion herein, unless otherwise specified, the same or similar numbers in different drawings represent the same or similar elements formed by the same or similar forming methods using the same or similar materials.

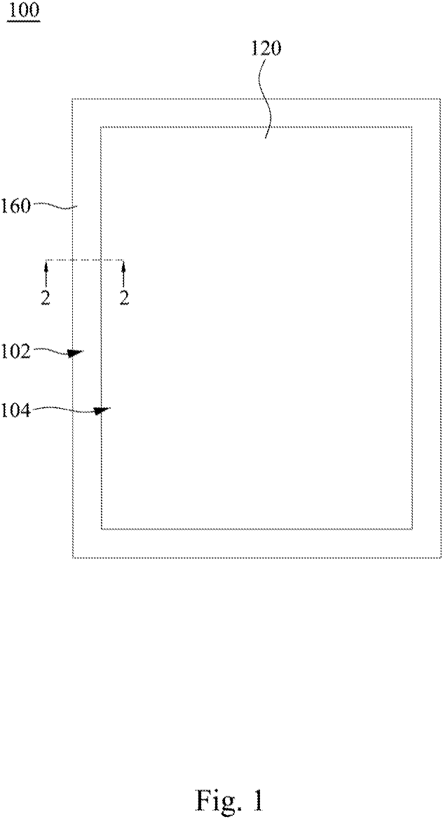

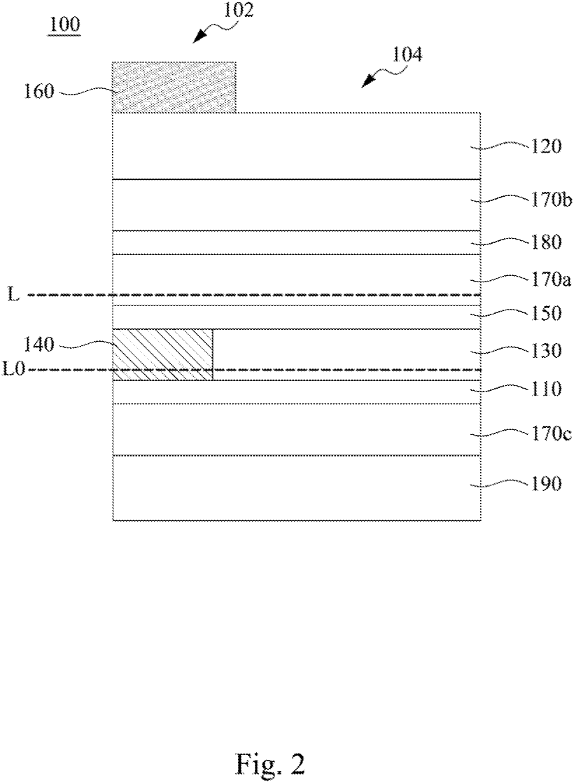

FIG. 1 is a top view of a flexible display device 100 according to one embodiment of the present disclosure. FIG. 2 is a cross-sectional view of the flexible display device 100 taken along line 2-2 of FIG. 1. As shown in FIG. 1 and FIG. 2, the flexible display device 100 includes a thin-film transistor (TFT) array substrate 110, a cover film 120, an electronic ink layer 130, an edge sealant 140, an electrode layer 150, and a reinforcement layer 160. The electronic ink 130 layer is located between the TFT array substrate 110 and the cover film 120. The electronic ink 130 layer may include a microcapsule therein, and the microcapsule may have a first color particle and a second color particle. The edge sealant 140 is located between the TFT array substrate 110 and the cover film 120 and surrounds the electronic ink layer 130. The edge sealant 140 defines a packaging area 102 of the flexible display device 100, in which the packaging area 102 vertically overlaps the edge sealant 140. The packaging area 102 is a non-display area and surrounds a display area 104 of the flexible display device 100. Furthermore, the electrode layer 150 is located on the electronic ink layer 130. The electronic ink layer 130 may be a common electrode capable of applying a voltage to the electronic ink layer 130 with pixel electrodes of the TFT array substrate 110. The reinforcement layer 160 is disposed along the packaging area 102.

In this embodiment, the reinforcement layer 160 is located on the cover film 120, and may serve as border decoration. A material of the reinforcement layer 160 may be polyimide (PI) or polyethylene terephthalate (PET), such as PI tape or PET tape, but the present disclosure is not limited in this regard. A thickness of the reinforcement layer 160 is in a range from 15 µ m to 100 µ m.

Since the flexible display device 100 includes the reinforcement layer 160 disposed along the packaging area 102, a position of a neutral axis of the packaging area 102 (i.e., a position having no stress when bending the flexible display device) may be adjusted. Layers above the neutral axis are in a compressed state when being bent, while layers below the neutral axis are in a neutral state or a tensile state when being bent. The compressed state easily leads to a wrinkle. When the wrinkle is in a bending state (e.g., static bending), stress concentration may occur to result in buckling. For example, a flexible display device in which no reinforcement layer 160 is disposed has a neutral axis present at a dotted line L0, while the flexible display device 100 having the reinforcement layer 160 has a neutral axis present at a dotted line L. That is, through the reinforcement layer 160, the position of the neutral axis is moved upwardly from the position of the dotted line L0 to the position of the dotted line L so as to transform the electrode layer 150 and the electronic ink layer 130 below the dotted line L to a neutral state or a tensile state when being bent.

In brief, when the flexible display device 100 is bent, the reinforcement layer 160 may transform films (e.g., the electrode layer 150, the electronic ink layer 130, and the TFT array substrate 110) that are at risk of buckling in the packaging area 102 from a compressed state to a neutral state or a tensile state, thereby avoiding wrinkles and buckling, and preventing interfacial delamination occurs during bending (e.g., dynamic bending).

The flexible display device 100 further includes a first optical adhesive 170a, a functional layer 180, a second optical adhesive 170b, a bottom protection layer 190, and a third optical adhesive 170c. The first optical adhesive 170a is located on the electrode layer 150. The first optical adhesive 170a, the second optical adhesive 170b, and the third optical adhesive 170c may be optical clear adhesive (OCA). The functional layer 180 is located on the first optical adhesive 170a. In some embodiments, the functional layer 180 may be a touch sensing layer or a front light module to provide the flexible display device 100 with a touch function or light for irradiating the electronic ink layer 130. The second optical adhesive 170b is located between the functional layer 180 and the cover film 120. The third optical adhesive 170c is located between the bottom protection layer 190 and the TFT array substrate 110.

It is to be noted that the connection relationships, the materials, and the advantages of the elements described above will not be repeated in the following description. In the following description, other types of flexible display devices will be described.

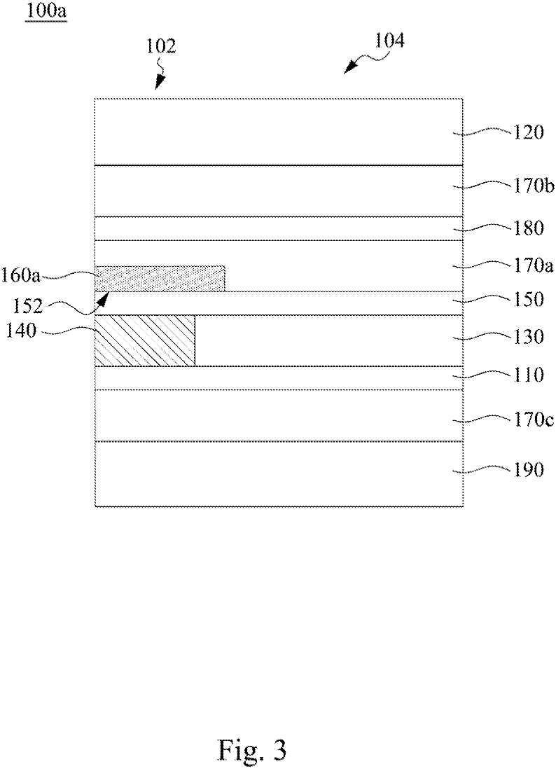

FIG. 3 is a cross-sectional view of a flexible display device 100a according to one embodiment of the present disclosure. The flexible display device 100a includes the TFT array substrate 110, the cover film 120, the electronic ink layer 130, the edge sealant 140, the electrode layer 150, a reinforcement layer 160a, and the first optical adhesive 170a. The difference between this embodiment and the embodiment of FIG. 2 is that the reinforcement layer 160a is a resin having a high Young’s modulus, and the reinforcement layer 160a is located on a top surface 152 of the electrode layer 150. Moreover, the first optical adhesive 170a is located on the electrode layer 150 and the reinforcement layer 160a, and the reinforcement layer 160a is located between the electrode layer 150 and the first optical adhesive 170a.

In this embodiment, the Young’s modulus of the reinforcement layer 160a is greater than the Young’s modulus of the first optical adhesive 170a. The reinforcement layer 160a may be coated on the electrode layer 150 of the packaging area 102 by spray printing, and is cured by ultraviolet or heat. The reinforcement layer 160a may move the neutral axis of the packaging area 102 upwardly to transform the electrode layer 150 in the packaging area 102 from a compressed state to a neutral state or a tensile state when being bent, thereby preventing the electrode layer 150 from wrinkles and buckling being bent.

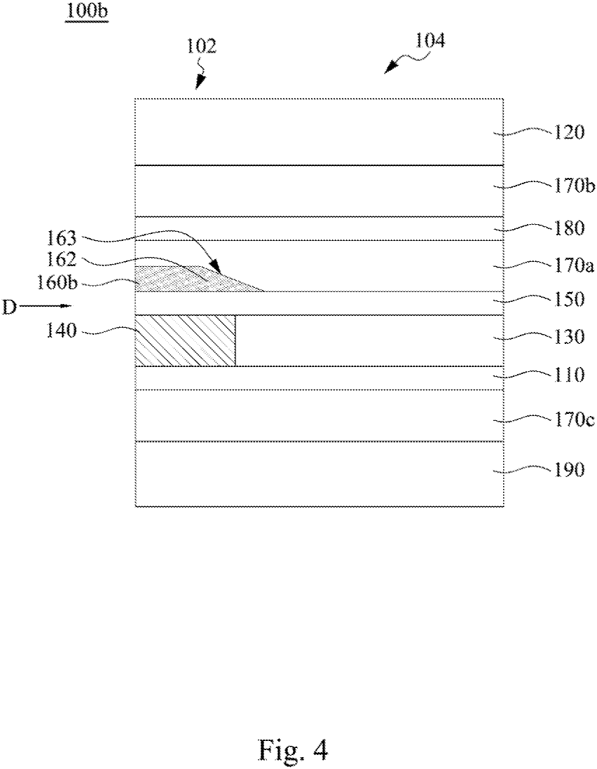

FIG. 4 is a cross-sectional view of a flexible display device 100b according to one embodiment of the present disclosure. The flexible display device 100b includes the TFT array substrate 110, the cover film 120, the electronic ink layer 130, the edge sealant 140, the electrode layer 150, a reinforcement layer 160b, and the first optical adhesive 170a. The difference between this embodiment and the embodiment of FIG. 3 is that the reinforcement layer 160b has an inner portion 162, and a thickness of the inner portion 162 is gradually decreased form the edge sealant 140 to the electronic ink layer 130 in a direction D such that the inner portion 162 has an inclined surface 163. In this embodiment, a material of the reinforcement layer 160b is a resin having a high Young’s modulus, and coating the resin includes coating the resin over an interface between the electronic ink layer 130 and the edge sealant 140 and coating the resin toward inside (i.e., in the direction D) for thickness gradient coating. The reinforcement layer 160b may prevent a stress at the interface between the electronic ink layer 130 and the edge sealant 140 from suddenly changing when the flexible display device 100b is bent.

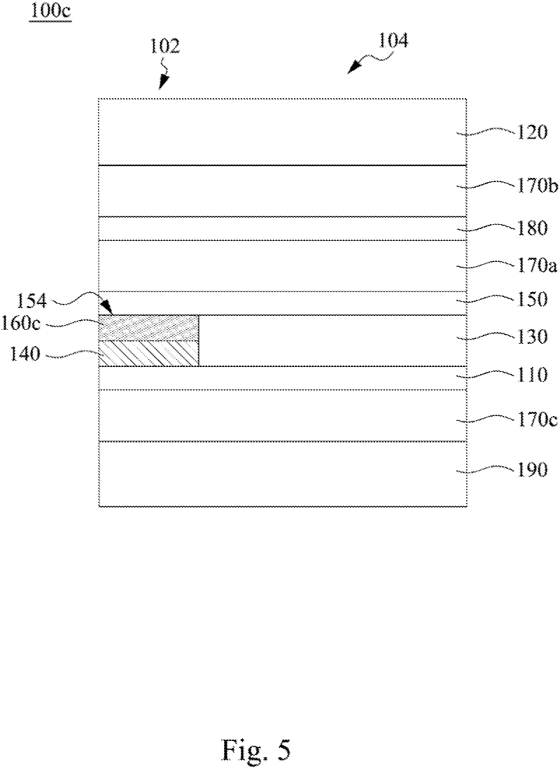

FIG. 5 is a cross-sectional view of a flexible display device 100c according to one embodiment of the present disclosure. The flexible display device 100c includes the TFT array substrate 110, the cover film 120, the electronic ink layer 130, the edge sealant 140, the electrode layer 150, a reinforcement layer 160c, and the first optical adhesive 170a. The difference between this embodiment and the embodiment of FIG. 4 is that the reinforcement layer 160c is located between the electrode layer 150 and the edge sealant 140, and a material of the reinforcement layer 160c is metal. The electrode layer 150 may include indium tin oxide (ITO) ceramic layer, Zinc oxide (ZnO) ceramic layer, or the like. In this embodiment, the reinforcement layer 160c may be formed on a bottom surface 154 of the electrode layer 150 by electroplating. The Young’s modulus of the reinforcement layer 160c may be in a range from tens to hundreds of GPa of metals, such as in a range from 10 GPa to 500 GPa, to adjust a position of a neutral axis, such that the electrode layer 150 in the packaging area 102 is in a neutral state to prevent wrinkles resulting in buckling or delamination when being bent. Since a product often needs to be cut and formed in the edge packaging area 102, laser cutting or knife cutting is required. High toughness metal (such as the reinforcement layer 160c) may further avoid micro-cracks in the ceramic layer caused by the cutting process to extend to an active area (e.g., the display area 104) to lead to failure when being bent.

In some embodiment, an inner side of the reinforcement layer 160c may further have a thickness gradient region shown in FIG. 4, and a thickness of the reinforcement layer 160c is gradually decreased in the direction D (see FIG. 4).

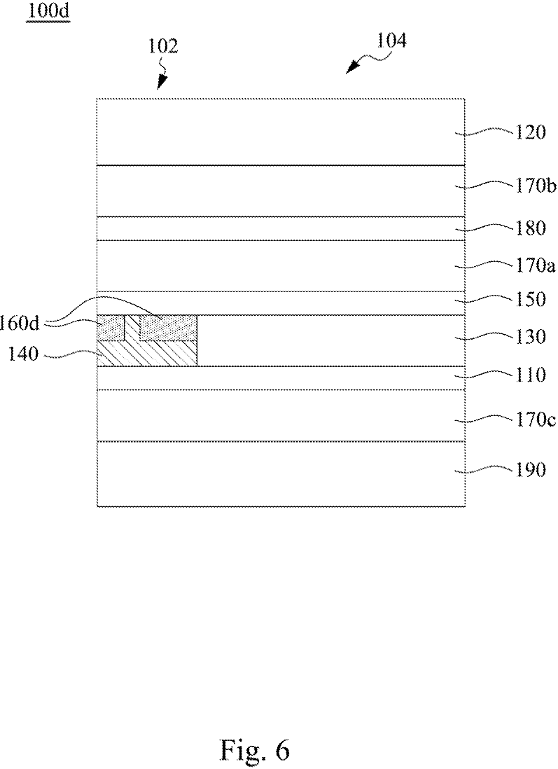

FIG. 6 is a cross-sectional view of a flexible display device 100d according to one embodiment of the present disclosure. The flexible display device 100d includes the TFT array substrate 110, the cover film 120, the electronic ink layer 130, the edge sealant 140, the electrode layer 150, a reinforcement layer 160d, and the first optical adhesive 170a. The difference between this embodiment and the embodiment of FIG. 5 is that the reinforcement layer 160d has a plurality of segments that are separated from each other, and a portion of the edge sealant 140 extends to a position between the segments to effectively prevent the micro-cracks from extending to the active area. In this embodiment, the reinforcement layer 160d has two separated segments shown in FIG. 5, but the present disclosure is not limited in this regard.

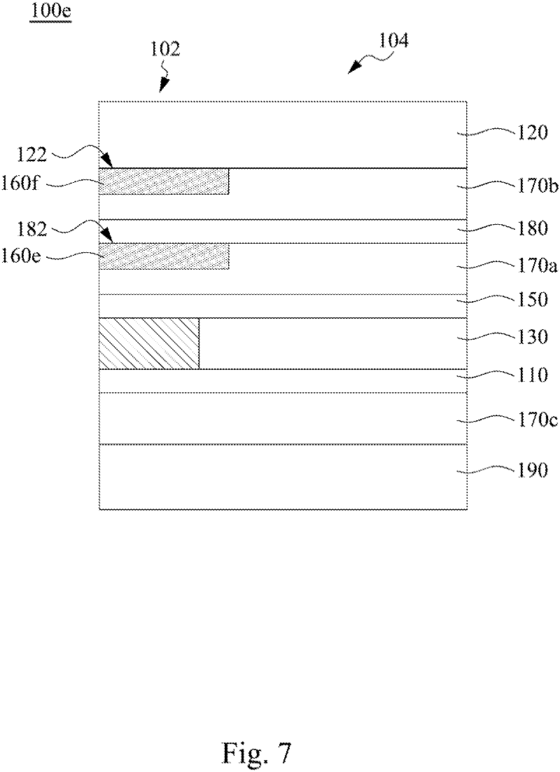

FIG. 7 is a cross-sectional view of a flexible display device 100e according to one embodiment of the present disclosure. The flexible display device 100e includes the TFT array substrate 110, the cover film 120, the electronic ink layer 130, the edge sealant 140, the electrode layer 150, a reinforcement layer 160e, the first optical adhesive 170a, the functional layer 180, and the second optical adhesive 170b. The difference between this embodiment and the embodiment of FIG. 3 is that the reinforcement layer 160e is located on a bottom surface 182 of the functional layer 180, and the flexible display device 100e further has a decorative ink layer 160f. The decorative ink layer 160f is disposed along the packaging area 102 and is located between the cover film 120 and the second optical adhesive 170b. As shown in FIG. 7, the decorative ink layer 160f is located on a bottom surface 122 of the cover film 120. The Young’s modulus of the decorative ink layer 160f is greater than the Young’s modulus of the second optical adhesive 170b. The decorative ink layer 160f may further adjust the position of the neutral axis of the packaging area 102.

In addition, the reinforcement layer 160e is located between the functional layer 180 and the electrode layer 150. In this embodiment, the reinforcement layer 160e is located on the bottom surface of the functional layer 180, and the reinforcement layer 160e may be another decorative ink layer. Due to the reinforcement layer 160e and the decorative ink layer 160f, not only the position of a neutral axis can be lifted, but also the color and luster of a decorative ink layer can be darkened or adjusted. Furthermore, the reinforcement layer 160e and the decorative ink layer 160f may prevent one decorative ink layer concentrated in a certain layer such that the step compensation of an optical adhesive is too difficult.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A flexible display device, comprising:
a thin-film transistor (TFT) array substrate;
a cover film;
an electronic ink layer located between the TFT array substrate and the cover film;
an edge sealant located between the TFT array substrate and the cover film, and surrounding the electronic ink layer, wherein the edge sealant defines a packaging area that vertically overlaps the edge sealant;
an electrode layer located on the electronic ink layer; and
a reinforcement layer disposed along the packaging area.

2. The flexible display device of claim 1, wherein the reinforcement layer is located on the cover film.

3. The flexible display device of claim 1, wherein a material of the reinforcement layer is polyimide (PI), polyethylene terephthalate (PET), resin, or metal.

4. The flexible display device of claim 1, wherein the reinforcement layer is located on a top surface of the electrode layer.

5. The flexible display device of claim 4, further comprising:
a first optical adhesive located on the electrode layer and the reinforcement layer.

6. The flexible display device of claim 5, wherein a Young’s modulus of the reinforcement layer is greater than a Young’s modulus of the first optical adhesive.

7. The flexible display device of claim 1, wherein the reinforcement layer is located between the electrode layer and the edge sealant.

8. The flexible display device of claim 7, wherein the reinforcement layer has a plurality of segments that are separated from each other, and a portion of the edge sealant extends to a position between the segments.

9. The flexible display device of claim 7, wherein a Young’s modulus of the reinforcement layer is in a range from 10 GPa to 500 GPa.

10. The flexible display device of claim 1, further comprising:
a first optical adhesive located on the electrode layer; and
a functional layer located on the first optical adhesive, wherein the reinforcement layer is located between the functional layer and the electrode layer.

11. The flexible display device of claim 1, further comprising:
a first optical adhesive located on the electrode layer;
a functional layer located on the first optical adhesive; and
a second optical adhesive located between the functional layer and the cover film.

12. The flexible display device of claim 11, further comprising:
a decorative ink layer disposed along the packaging area and located between the cover film and the second optical adhesive.

13. The flexible display device of claim 12, wherein a Young’s modulus of the decorative ink layer is greater than a Young’s modulus of the second optical adhesive.

14. The flexible display device of claim 1, wherein the reinforcement layer has an inner portion, and a thickness of the inner portion is gradually decreased form the edge sealant to the electronic ink layer such that the inner portion has an inclined surface.

15. The flexible display device of claim 1, wherein a thickness of the reinforcement layer is in a range from 15 µm to 100 µm.

16. The flexible display device of claim 1, further comprising:
a bottom protection layer; and
a third optical adhesive located between the bottom protection layer and the TFT array substrate.

17. A flexible display device, comprising:
a thin-film transistor (TFT) array substrate;
a cover film;
an electronic ink layer located between the TFT array substrate and the cover film;
an edge sealant surrounding the electronic ink layer;
an electrode layer located on the electronic ink layer; and
a reinforcement layer above the edge sealant and vertically overlapping the edge sealant.
